(19) United States
(12) Patent Application Publication
(10) Pub. No.: US 2026/0123563 A1
(43) Pub. Date: May 7, 2026

(54) DIFFERENTIAL STEER CRAWLING CONTROL SYSTEM FOR DUAL PATH MACHINE

(71) Applicant: AGCO Corporation, Duluth, GA (US)

(72) Inventors: Benjamin Adam WELLE, Hesston, KS (US); Brendon C. Nafziger, Hesston, KS (US)

(21) Appl. No.: 19/381,413

(22) Filed: Nov. 6, 2025

Related U.S. Application Data
(60) Provisional application No. 63/717,315, filed on Nov. 7, 2024.

(51) Int. Cl. A01B 69/00; B62D 9/00

(52) U.S. Cl. CPC A01B 69/007; B62D 9/002

(57) ABSTRACT

An agricultural machine includes a harvesting component, a differential axle assembly, a steering mechanism, first and second drive wheels, a steering motor coupled to the differential axle assembly and a control system. The control system includes a status sensor, a GPS sensor, and a plurality of input sensors. The controller is configured to determine when the agricultural machine is operating in a crawl condition, and based on the determination, operate the agricultural machine in a crawl mode corresponding to the crawl condition. The crawl mode includes actuating the steering motor to increase torque applied to one of the first and second drive wheels until the agricultural machine is no longer operating in the crawl condition.

### CROSS-REFERENCE TO RELATED APPLICATION

This application claims the benefit of the filing date of U.S. Provisional Patent Application 63/717,315, filed on Nov. 7, 2024, the entire disclosure of which is incorporated herein by reference.

### BACKGROUND

The present disclosure relates to control systems and methods for controlling operation of agricultural machines, such as self-propelled windrowers.

Some situations may occur where the agricultural machine cannot fully climb a hill with the gradeability capability of the drive system. Additionally, the agricultural machine may become stuck in a rut and may need some extra ground drive torque to get out of the stuck condition. Furthermore, in some cases, the agricultural machine may be driven on uneven and sometimes muddy surfaces. This may cause one or more of the drive wheels to become stuck and slip, which can cause the agricultural machine to pivot around the stuck wheel.

### BRIEF DESCRIPTION

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, a control system for an agricultural machine is provided. The agricultural machine includes a harvesting component, a differential axle assembly, a steering mechanism, first and second drive wheels, and a steering motor coupled to the differential axle assembly and configured to increase torque applied to one of the first and second drive wheels while simultaneously decreasing torque applied to the other of the first and second drive wheels. The control system includes a status sensor configured to interface with the harvesting component and generate a status signal representative of an operational status of the harvesting component. The control system also includes a GPS sensor coupled to the agricultural machine and configured to generate a GPS signal representative of a ground speed of the agricultural machine. Furthermore, the control system includes one or more input sensors. Each input sensor is configured to generate an input signal. The control system also includes a controller communicatively coupled to the status sensor, the GPS sensor, and the one or more input sensors. The controller is configured to receive the GPS signal from the GPS sensor, and, based on the GPS signal, determine that the ground speed of the agricultural machine is below a pre-determined threshold ground speed value. The controller is also configured to receive the status signal from the status sensor, and, based on the status signal, determine that the harvesting component is operating in an operating mode. Additionally, the controller is configured to receive the one or more input signals from the one or more input sensors, and, based on the input signals, determine that the agricultural machine is in a crawl condition. Moreover, the controller is configured to initiate a crawl mode corresponding to the crawl condition based on the crawl condition determination. Initiating the crawl mode includes actuating the steering motor to increase the torque applied to one of the first and second drive wheels.

A variety of additional aspects will be set forth in the detailed description that follows. These aspects can relate to individual features and to combinations of features. Advantages of these and other aspects will become more apparent to those skilled in the art from the following description of the exemplary embodiments which have been shown and described by way of illustration. As will be realized, the present aspects described herein may be capable of other and different aspects, and their details are capable of modification in various respects. Accordingly, the figures and description are to be regarded as illustrative in nature and not as restrictive.

### BRIEF DESCRIPTION OF THE DRAWINGS

The figures described below depict various aspects of systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1A is a perspective view of an agricultural machine constructed in accordance with an embodiment of the invention;

FIG. 1B is a front plan view of the agricultural machine of FIG. 1A, with the harvesting component removed for clarity;

FIG. 2 is a schematic diagram of a control system of the agricultural machine of FIG. 1A;

FIG. 3 is a flow diagram illustrating an automatic implementation of a selective crawl mode of the agricultural machine of FIG. 1A, implemented by the control system of FIG. 2;

FIG. 4 is a flow diagram illustrating a process for determining whether the agricultural machine is in a first crawl condition, implemented by the control system of FIG. 2;

FIG. 5 is a flow diagram illustrating a process for determining whether the agricultural machine is in a second crawl condition, implemented by the control system of FIG. 2;

FIG. 6 is a flow diagram illustrating a process for determining whether the agricultural machine is in a third crawl condition, implemented by the control system of FIG. 2; and

FIG. 7 is a flow diagram of implementation of a selective crawl mode of the agricultural machine of FIG. 1A based on manual initiation by an operator of the agricultural machine.

Unless otherwise indicated, the figures provided herein are meant to illustrate features of embodiments of this disclosure. These features are believed to be applicable in a wide variety of systems comprising one or more embodiments of this disclosure. As such, the figures are not meant to include all conventional features known by those of ordinary skill in the art to be required for the practice of the embodiments disclosed herein. While the drawings do not necessarily provide exact dimensions or tolerances for the illustrated components or structures, the drawings are to scale with respect to the relationships between the components of the structures illustrated in the drawings.

### DETAILED DESCRIPTION

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized, and changes may be made without departing from the scope of the claims. The following description is, therefore, not limiting. The scope of the present invention is defined only by the appended claims, along with the full scope of equivalents to which such claims are entitled.

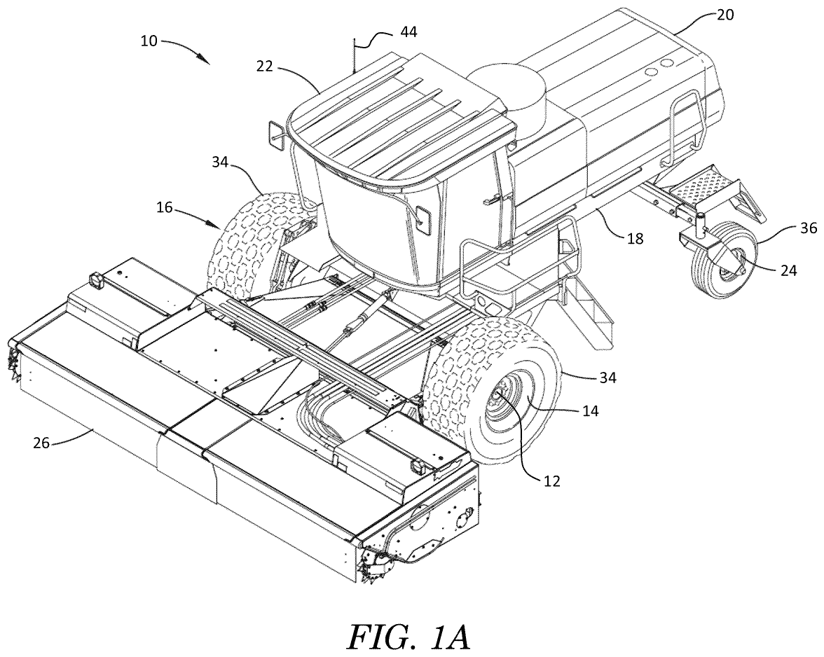

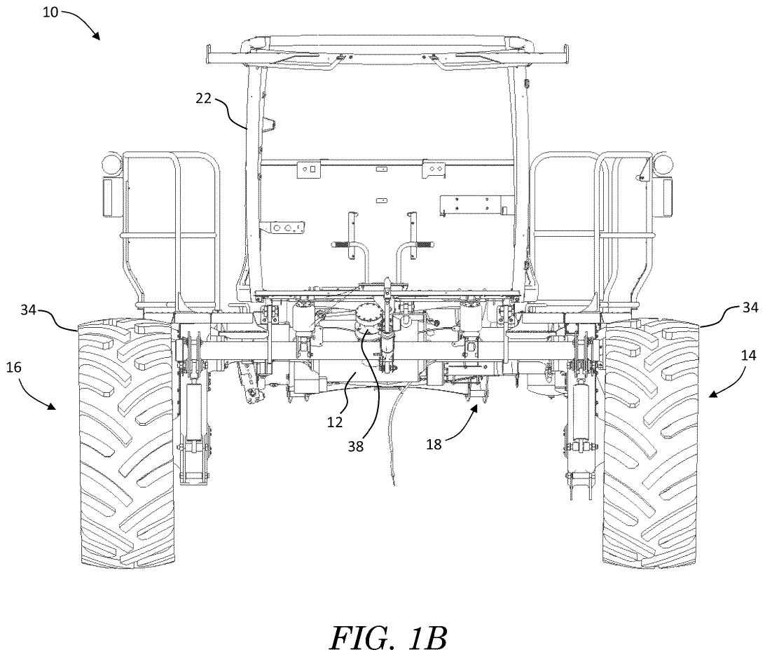

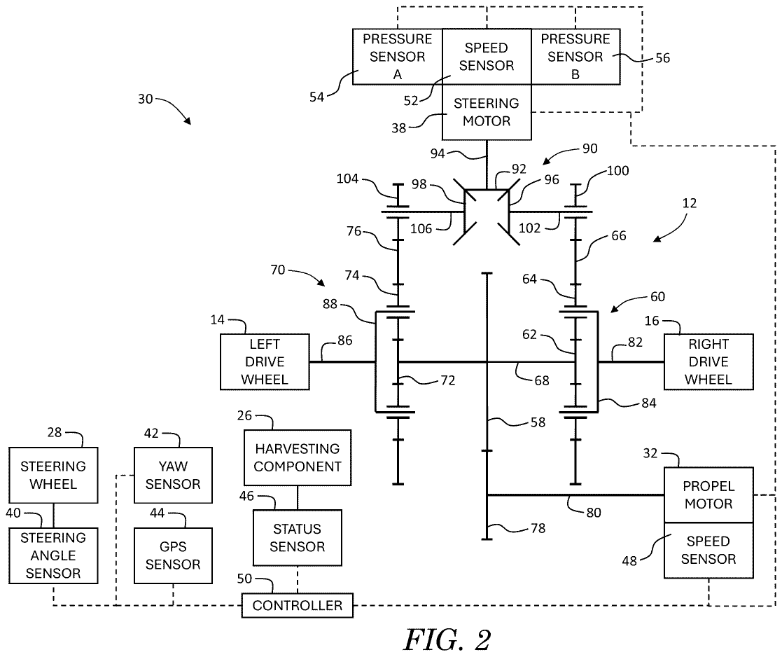

Turning to FIGS. 1A, 1B, and 2, an agricultural machine 10, in which a control system 30 may be incorporated, is depicted. In the example embodiment, the agricultural machine 10 is a dual path machine, which relies on a differential axle assembly 12 to drive left and right drive wheels 14 and 16. The differential axle assembly 12 also enables steering of the agricultural machine 10 by differential control of the relative rotational speeds of the drive wheels 14 and 16 on the left and right hand sides of the machine via a steering motor 38, as described further below.

In the example, the agricultural machine 10 also includes a chassis 18, an engine compartment 20, a cab 22, a set of caster wheels 24, a harvesting component 26, a steering mechanism 28 (also referred to herein as a “steering wheel”), and the control system 30.

The chassis 18 supports the engine compartment 20, cab 22, and harvesting component 26 and may include a number of frame rails, cross beams, and other structural members (not shown). The chassis 18 may also include a number of mounting bosses or mounting points (not shown) for mounting the above components to the chassis 18.

The engine compartment 20 encloses an engine (not shown) and other components of a drive system. The engine compartment 20 is mounted on the chassis 18 behind the cab 22. The engine compartment 20 may include doors and/or removable access panels (not shown) for servicing the engine.

The cab 22 protects an operator (hereinafter “driver”) and the steering mechanism 28 from outside elements. The cab 22 may include an enclosed canopy having a door and several windows or windshields. A seat and other ergonomic features (not shown) from which the driver may control the agricultural machine 10 may be positioned in the cab 22. In some embodiments, user input mechanisms may be enclosed in the cab 22 and/or integrated with a mobile electronic or computing device of the user, and may include a user interface such as a touch screen or button for selection of control input from a remote or automated source, such as GPS way lines or more advanced autonomous drive control.

As shown in FIG. 2, the agricultural machine 10 includes a propel motor 32. The propel motor 32 powers the drive wheels 14 and 16. In an embodiment, the engine may be a gasoline or diesel-powered internal combustion engine or any other suitable power source. The engine may be configured to power the propel motor 32, for example, via a hydraulic or pneumatic system comprising hydraulic or pneumatic pumps, lines, valves, and the like (not shown). In other embodiments, the engine may be configured to power the propel motor 32 via electric current, for example, by operating a generator or alternator.

Referring to FIGS. 1A, 1B, and 2, the drive wheels 14 and 16 are driven wheels that may include drive tires 34 mounted thereon. The drive tires 34 may include traction lugs or other features for improved grip. The drive tires 34 could also be replaced with tracks on some agricultural machines. The drive wheels 14 and 16 may be positioned near a front end of the chassis 18 and may support a majority of the weight of the agricultural machine 10. The drive wheels 14 and 16 may be non-steerable and independently driven.

The caster wheels 24 are non-driven wheels spaced behind the drive wheels 14 and 16 and may include non-drive tires 36 mounted thereon. The non-drive tires 36 may have annular ridges and/or grooves for allowing the non-drive tires 36 to more easily pass over mud, loose dirt, gravel, and other ground conditions. The caster wheels 24 may be configured to swivel about a vertically extending axis, for example, in either a free-wheeling mode or a steering mode. In another embodiment, the caster wheels 24 are “front casters” spaced in front of the drive wheels 14 and 16. The tires 36 are not limited to being non-driven and may have hydraulic or electric assist.

The harvesting component 26 cuts and swaths crops into a windrow and may be removably attached to the front end of the chassis 18. The harvesting component 26 may be driven by the engine, for example, via an auxiliary or power take-off (PTO) drive (not shown). In one or more embodiments, the harvesting component 26 includes one or more blades, such as grass blades, rotary blades, reciprocating blades, brush cutter blades, straw reaper blades, harvest knives or the like.

The steering mechanism 28 allows the driver to provide user drive inputs to control the agricultural machine 10 and may include a traditional circular-shaped steering wheel. Alternatively, the steering mechanism 28 may include handlebars, an acceleration pedal, a brake pedal, a yoke, a joystick, and other input devices.

As shown in FIG. 2, the agricultural machine 10 includes a steering motor 38. The steering motor 38 is configured to adjust a rotational speed to the drive wheels 14 and 16 relative to each other, for example, via the differential axle assembly 12, as described further herein. That is, the steering motor 38 is configured to increase torque to one of the drive wheels 14 and 16 while simultaneously reducing torque to the other of the drive wheels 14 and 16. The steering motor 38 uses the unequal torque of the drive wheels 14 and 16 to achieve steering of the agricultural machine 10. The engine may be configured to power the steering motor 38, for example, via a hydraulic or pneumatic system comprising hydraulic or pneumatic pumps, lines, valves, and the like. In other embodiments, the engine may be configured to power the steering motor 38 via electric current, for example, by operating a generator or alternator.

### Control System

The control system 30 controls the harvesting component 26, the propel motor 32 (which powers the drive wheels 14 and 16), and the steering motor 38. The control system 30 includes a controller 50 coupled in communication with a number of sensors. The sensors may be switches, electrical resistance sensors, temperature sensors, touch sensors capacitance sensors, position sensors, angle sensors, speed sensors, proximity sensors, Hall-effect sensors, accelerometers, gyroscopes, pressure sensors, time-of-flight sensors, optical sensors, imaging sensors, cameras, and the like.

In the example, the control system 30 includes a steering angle sensor 40, which interfaces with the steering mechanism 28 for sensing an angle or orientation of the steering mechanism 28. The control system 30 also includes a yaw sensor 42 to determine orientation and angular velocity of the agricultural machine 10. In an embodiment, the yaw sensor 42 may include a gyroscope, for example. The control system 30 also includes a global positioning satellite (GPS) sensor 44 to determine a position of the agricultural machine 10. The GPS sensor 44 may be placed on top of the cab 22 (see FIG. 1A). The control system includes a status sensor 46, which interfaces with the harvesting component 26 to determine an operational status of the harvesting component, i.e., whether the harvesting component 26 is in an operating mode or a non-operating mode. In one or more embodiments, an operating mode correlates to blade movement in a harvesting pattern and a non-operating mode correlates to non-movement of the blade(s) in the harvesting pattern.

In the example embodiment, the control system 30 may be completely integrated into the agricultural machine 10 or may incorporate external components such as a smartphone or tablet or other portable, remote, or onboard control devices. The controller 50 implements a selective crawl mode, which will be described in more detail below.

In the example embodiment, the control system 30 also includes a propel motor speed sensor 48 configured to sense a speed of the propel motor 32. For example, the speed sensor 48 measures an output shaft rotation speed of the propel motor and transmits a speed value to the controller 50. The speed of the propel motor 32 may be associated with a commanded speed of the agricultural machine 10. For example, if the agricultural machine 10 is traversing the ground without any slippage of the drive wheels 14 and 16 relative to the ground, the speed of the propel motor is indicative of the ground speed of the agricultural machine 10.

The control system 30 also includes a speed sensor 52 and two (2) pressure sensors 54 and 56. The speed sensor 52 is configured to sense a speed of the steering motor 38. For example, the speed sensor 52 measures the output shaft rotation speed of the propel motor and transmits a speed value to the controller 50. Pressure sensor A, reference character 54, is configured to sense a fluid pressure (for example, a hydraulic or pneumatic pressure) at the “A” side of the steering motor 38, such as a fluid pressure in a line coupled to the “A” side of the steering motor 38. Likewise, pressure sensor B, reference character 56, is configured to sense a fluid pressure (for example, a hydraulic or pneumatic pressure) at the “B” side of the steering motor 38, such as a fluid pressure in a line coupled to the “B” side of the steering motor 38. The pressure values are transmitted to the controller 50, as described herein.

It is noted that the sensors 40, 42, 44, 46, 48, 52, 54, and 56 may be independent from each other or may have overlapping or dual purposes depending on the context, as described herein.

The controller 50 may include computing components such as a processor, a memory, power components, and communication components for communicating with the input sensors 40, 42, 44, 46, 48, 52, 54, 56, and other components. The controller 50 may perform all logic functions, or it may be divided into multiple individual controllers, each participating in the control execution. Portions of distributed control and signal processing may exist within input and output devices as well. The controller 50 may run a computer program stored in or on computer-readable medium, such as the memory, residing on or accessible by the controller 50. The computer programs preferably comprise ordered listings of executable instructions for implementing logical functions in the controller 50. The computer programs can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this document, a “computer-readable medium” can be any means that can contain, store, communicate, propagate or transport the program for use by or in connection with the instruction execution system, apparatus, or device. The computer-readable medium can be, for example, but is not limited to, an electronic, magnetic, optical, electromagnetic, infrared, or semi-conductor system, apparatus, device, or propagation medium. More specific, although not inclusive, examples of the computer-readable medium may include the following: an electrical connection having one or more wires, a random-access memory (RAM), a read-only memory (ROM), an erasable, programmable, read-only memory (EPROM or Flash memory), an optical fiber, and the like. The computer-readable medium may be one or more components incorporated into the controller 50 and/or other devices of the control system 30.

The memory may include, for example, removable and non-removable memory elements such as RAM, ROM, flash, magnetic, optical, USB memory devices, and/or other conventional memory elements. The memory may store various data associated with the control system 30, such as the computer program and code segments mentioned above, or other data for instructing components of the agricultural machine 10 to perform the steps described herein. Further, the memory may store data retrieved from the controller 50 and other components of the agricultural machine 10 or other machines that act as data sources.

### Differential Axle Assembly

Referring to FIG. 2, the drive train components of the differential axle assembly 12, which delivers motive power to and provides steering of the drive wheels 14 and 16, are schematically depicted. The differential axle assembly 12 includes a first planetary gear set 60 and a second planetary gear set 70. The first and second planetary gear sets 60, 70 are axially aligned and are substantially the same. In the example embodiment, the first planetary gear set 60 is configured to drive the drive wheel 16 and the second planetary gear set 70 is configured to drive the drive wheel 14.

The first planetary gear set 60 includes a central sun gear 62, three or more planetary gears 64 rotatably engaging the respective sun gear, and an outer ring gear 66 constraining and rotatably engaging the planetary gears 64. The second planetary gear set 70 includes a central sun gear 72, three or more planetary gears 74 rotatably engaging the respective sun gear, and an outer ring gear 76 constraining and rotatably engaging the planetary gears 74.

The sun gears 62 and 72 of the first and second planetary gear sets 60 and 70, respectively, are fixedly coupled to a common shaft 68 and rotate in unison. A driven gear 58 is fixedly coupled to the common shaft 68 and is drivingly rotated by a driving gear 78 coupled to an output shaft 80 of the propel motor 32.

The first planetary gear set 60 includes an output shaft 82 drivingly coupled to a planetary carrier 84 of the first planetary gear set 60. The planetary carrier 84 is coupled to the three or more planetary gears 64. The output shaft 82 is drivingly coupled to the drive wheel 16. The second planetary gear set 70 includes an output shaft 86 drivingly coupled to a planetary carrier 88 of the second planetary gear set 70. The planetary carrier 88 is coupled to the three or more planetary gears 74. The output shaft 88 is drivingly coupled to the drive wheel 14.

In the exemplary embodiment, each of the outer ring gears 66 and 76 are rotatably driven in a forward or reverse direction by the steering motor 38 through a differential bevel gear arrangement 90. The differential bevel gear arrangement 90 includes a driving bevel gear 92 coupled to an output shaft 94 of the steering motor 38. The driving bevel gear 92 is rotatably engaged with driven bevel gears 96 and 98.

The driven bevel gear 96 is drivingly coupled to a gear 100 via a shaft 102. The gear 100 is rotatably engaged with the outer ring gear 66 of the first planetary gear set 60. Similarly, the driven bevel gear 98 is drivingly coupled to a gear 104 via a shaft 106. The gear 104 is rotatably engaged with the outer ring gear 76 of the secondary planetary gear set 70. In this manner, when the steering motor 38 rotates the bevel gear 92, the driven bevel gears 96 and 98 are rotated in opposite directions. As such, the outer ring gears 66 and 76 are rotated in opposite directions. This enables the speed of the drive wheels 14 and 16 to be independently controlled via the steering motor 38. This is advantageous because the torque provided by the steering motor 38 is additional torque on the outer ring gears 66 and 76 that can add to the torque provided by the propel motor 32. For example, when the propel motor 32 is provided forward torque, the steering motor can add additional torque to one of the two (2) drive wheels in a forward direction. By alternating the rotation of the steering motor 38, the control system can implement a selective crawl mode, alternately applying additional torque to the drive wheels 14 and 16, as described below.

### Selective Crawl Mode

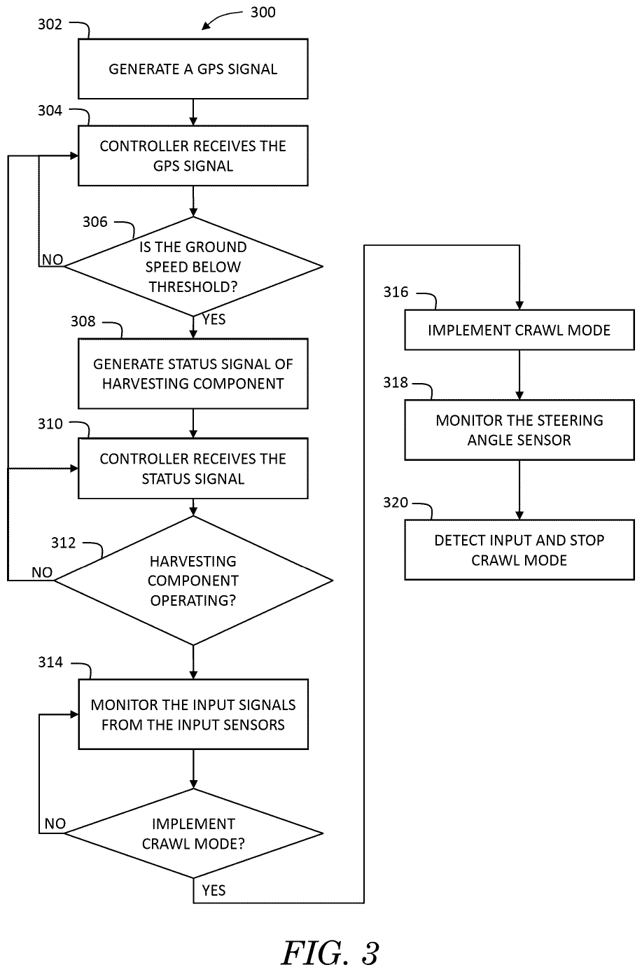

FIG. 3 is a flowchart illustrating an exemplary computer-implemented method 300 for automatic implementation of a selective crawl mode of the agricultural machine 10, in accordance with embodiments of the present disclosure. When the controller 50 identifies that the agricultural machine 10 is operating in a crawl condition, the method 300 advantageously automatically initiates a selective crawl mode by actuating the steering motor 38 to apply torque from the steering motor 38 to one or more of the drive wheels 14 and 16. The operations described herein may be performed in the order shown in FIG. 3 or may be performed in a different order. Furthermore, some operations may be performed concurrently as opposed to sequentially. In addition, some operations may be optional.

The computer-implemented method 300 is described below, for ease of reference, as being executed by exemplary devices and components introduced with the embodiments illustrated in FIGS. 1A, 1B, and 2. In one embodiment, the method 300 may be implemented by the agricultural machine 10, via the controller 50 (shown in FIG. 2). The method 300 may be implemented on other computing devices and/or systems through the utilization of processors, transceivers, hardware, software, firmware, or combinations thereof. A person having ordinary skill will further appreciate that responsibility for all or some of the actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the operations outlined herein. The program(s) stored on the computer-readable medium(s) may instruct the processor or processing units to perform additional, fewer, or alternative actions, including those discussed elsewhere herein.

In the example embodiment, before the controller 50 may implement the selective crawl mode of the agricultural machine 10, the controller 50 determines whether operation of the agricultural machine 10 meets one or more conditions. The conditions may be pre-determined. For example, for the selective crawl mode to be available for operation, the agricultural machine must be moving at or below a threshold ground speed and the harvesting component 26 must be operating, i.e., in the operating mode. Thus, the controller 50 may initially determine whether the agricultural machine 10 is at or below a pre-determined threshold ground speed. In an embodiment, if the agricultural machine 10 in a “road mode,” which enables an increased ground speed, as opposed to a “field mode,” the selective crawl mode may be disabled and/or unavailable.

For example, the GPS sensor 44 may receive data representative of a location, direction, and/or ground speed of the agricultural machine 10 and, at operation 302, may generate a GPS signal representative of the ground speed and transmit the signal to the controller 50. As used herein, the term “signal” includes a stream of values. For example, the GPS signal may include a stream of values, which may be changing values as the GPS sensor 44 is moved. Alternatively, one or more drive wheel sensors may sense an rpm or speed of the drive wheels 14 and 16 and transmit this information to the controller 50. At operation 304, the controller 50 may receive the GPS signal representative of the ground speed from the GPS sensor 44.

At operation 306, the controller 50 may determine that the ground speed of the agricultural machine 10 is below a pre-determined threshold ground speed based on the GPS signal. For example, the controller 50 may interpret the signal received from the GPS sensor 44 to determine the ground speed of the agricultural machine 10 and compare the speed to the pre-determined threshold ground speed value. If the ground speed is at or above the pre-determined threshold ground speed value, the controller 50 may continue to monitor the ground speed. If the ground speed is below the pre-determined threshold ground speed value, the method 300 may continue.

The controller 50 may also determine whether the harvesting component 26 is in the operating mode. For example, the status sensor 46 may receive data representative of an operational status of the harvesting component 26 (e.g., data representing a control or command status of the component 26 and/or analog data indicative of motion of blades or other components of the harvesting component 26) and, at operation 308, may generate a status signal representative of the operational status and transmit the signal to the controller 50. At operation 310, the controller 50 may receive the status signal representative of the operational status of the harvesting component 26 from the status sensor 46.

At operation 312, the controller 50 may determine, from the status signal, that the harvesting component 26 is in the operating mode. If the harvesting component 26 is in the non-operating mode, however, the controller 50 may continue to monitor the ground speed and/or the operational mode of the harvesting component 26. If the harvesting component 26 is in the operating mode, the method 300 may continue.

At operation 314, the controller 50 may receive and monitor the input signals from the input sensors 40, 42, 44, 46, 48, 52, 54, and 56 to determine whether to implement the selective crawl mode. In one or more embodiments, the monitoring at operation 314 may be initiated based on determination that the ground speed of the agricultural machine 10 and the operational status of the harvesting component 26 satisfy the constraints described in preceding paragraphs. For example, at operation 314 the controller 50 may determine whether the agricultural machine 10 meets one or more pre-determined crawl conditions based on the input signals from the input sensors 40, 42, 44, 46, 48, 52, 54, and 56. If the input signals from the input sensors 40, 42, 44, 46, 48, 52, 54, and 56 indicate that the selective crawl mode should be implemented, at operation 316, the controller 50 implements the selective crawl mode corresponding to the pre-determined crawl condition.

During the selective crawl mode, the controller 50 may continuously monitor the steering angle sensor 40 for input from the operator at operation 318. If, based on the input signal received by the controller 50 from the steering angle sensor 40, the controller 50 detects any input from the operator (e.g., rotation or orientation of the steering mechanism 28) during the selective crawl mode operation, the controller 50 stops the selective crawl mode, returning full control of the agricultural machine 10 to the operator at operation 320.

### Crawl Condition/Mode A

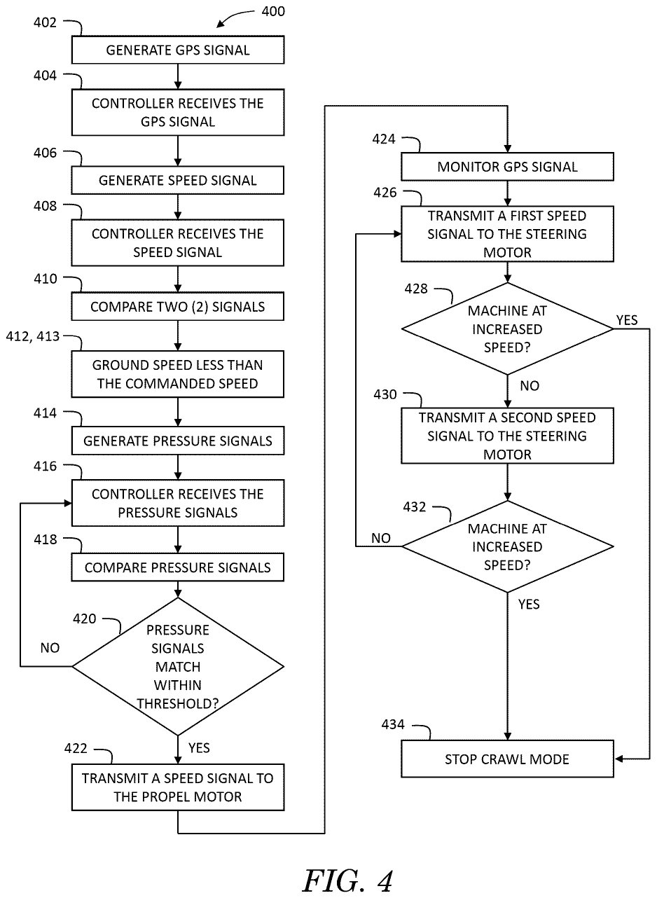

FIG. 4 is a flowchart illustrating an exemplary computer-implemented method 400 for determining whether the agricultural machine 10 is in a first crawl condition (referred to herein as “crawl condition A”) for activating a first selective crawl mode. As discussed above, at operation 314, the controller 50 may monitor the input signals from the input sensors 40, 42, 44, 46, 48, 52, 54, and 56.

In the example embodiment, the controller 50 may determine whether the propel motor speed sensor 48 and the GPS sensor 44 agree on a ground speed of the agricultural machine 10. For example, the GPS sensor 44 may receive data representative of a location, direction, and/or ground speed of the agricultural machine 10 and, at operation 402, may generate a signal representative of the ground speed and transmit the signal to the controller 50. At operation 404, the controller 50 may receive the signal representative of the ground speed from the GPS sensor 44.

In addition, at operation 406, the speed sensor 48 may generate a signal representative of a speed or RPM of the propel motor 32 and transmit the signal to the controller 50. In an embodiment, the propel motor speed may be associated with a predicted ground speed of the agricultural machine 10, i.e., the commanded speed input by the operator. At operation 408, the controller 50 may receive the signal representative of the propel motor speed or RPM.

At operation 410, the controller 50 may compare the signals received from the GPS sensor 44 and the speed sensor 48. At operation 412, based on the comparison, the controller 50 may determine that the two (2) signals indicate that the ground speed of the agricultural machine 10 is less than the commanded speed. For example, each of the GPS sensor 44 and the speed sensor 48 may indicate that the ground speed of the agricultural machine 10 is less than the commanded ground speed. In such a scenario, one or more of the drive wheels 14 and 16 of the agricultural machine 10 may be stuck or jammed, resulting in the wheel turning at a speed less than the commanded speed. Alternatively, based on the comparison, at operation 413, the controller 50 may determine that the ground speed indicated by the two (2) signals do not match, or do not match within a threshold amount. For example, the GPS sensor may indicate that the ground speed of the agricultural machine 10 is less than the predicted ground speed of the agricultural machine 10 based on the signal from the speed sensor 48. In such a scenario, the drive wheels 14 and 16 of the agricultural machine 10 may be spinning in the soil.

Furthermore, the controller 50 may determine that the agricultural machine 10 is moving, or trying to move, in a generally straight direction. For example, the pressure sensors A and B (reference characters 54 and 56) may sense a pressure (for example, a hydraulic or pneumatic pressure) in respective lines coupled to the steering motor 38 and, at operation 414, may generate respective signals representative of the pressures and transmit the signals to the controller 50. At operation 416, the controller 50 may receive the signals from the pressure sensors A and B. At operation 418, the controller 50 may compare the signals from the pressure sensors A and B and, at operation 420, determine that the two signals match within a threshold amount. For example, in an embodiment, the controller 50 may determine, based on the comparison, that the two signals indicate a pressure differential across the steering motor 38 equal to or less than two hundred pounds per square inch (200 psi). If the pressures do not match with the threshold amount, the controller 50 continues the monitor the pressures. It is noted that the pressure differential can be determined or pre-determined, and can be any value that enables the agricultural machine 10 to function as described herein.

Based on the above condition determinations (i.e., that the agricultural machine 10 is in “crawl condition A”), the controller 50 may implement an associated selective crawl mode (referred to herein as “crawl mode A”). Crawl mode A includes operating or actuating the steering motor 38 in an alternating manner, for a pre-determined period in each direction, and commanding an increased ground speed relative to the operator-commanded ground speed. After the increased ground speed is met, the controller 50 returns the agricultural machine 10 back to the original operator-commanded speed. These operations are described in more detail below.

At operation 422, the controller 50 may transmit a speed signal to the propel motor 32, increasing the speed of the motor by a pre-determined amount. For example, in an embodiment, the speed signal may indicate that the propel motor 32 is to increase its speed an amount in a range between and including five percent (5%) to twenty-five percent (25%). At operation 424, the controller 50 may monitor the GPS sensor 44. As discussed above, the GPS sensor 44 may receive data representative of a ground speed of the agricultural machine 10 and may generate and transmit a signal representative thereof.

At operation 426, the controller 50 may transmit a first speed signal to the steering motor 38 actuating the steering motor 38 in a first direction. By actuating the steering motor 38 in the first direction, the differential bevel gear arrangement 90 (shown in FIG. 2) applies additional torque to one of the drive wheels 14 and 16. The controller 50 may actuate the steering motor 38 in the first direction for a predetermined period. In an example embodiment, the first speed signal may actuate the steering motor 38 for a period of five seconds (5 s). It is noted that the period may be any period that enables the agricultural machine 10 to function as described herein. The period(s) may be predetermined, varied according to present conditions (such as the signals received or calculations/determinations made according to the description herein) or otherwise within the scope of the present invention.

At operation 428, the controller 50 may determine whether the agricultural machine 10 has achieved a ground speed substantially equal to the increased speed commanded by the controller 50 at operation 422 above. For example, the controller 50 may receive the signal representative of the ground speed from the GPS sensor 44 and compare the signal speed to the increased commanded speed. If the ground speed, as indicated by the GPS signal, is substantially equal to the increased speed commanded by the controller 50, the method continues at operation 434.

If the ground speed, as indicated by the GPS signal, is not substantially equal to the commanded increased speed, at operation 430, the controller 50 may transmit a second speed signal to the steering motor 38 actuating the steering motor 38 in a second direction, opposite the first direction. By actuating the steering motor 38 in the second direction, the differential bevel gear arrangement 90 applies additional torque to the other one of the drive wheels 14 and 16. The controller 50 may actuate the steering motor 38 in the second direction for a predetermined period. In an example embodiment, the second speed signal may actuate the steering motor 38 for a period of five seconds (5 s). It is noted that the period may be any period that enables the agricultural machine 10 to function as described herein. The period(s) may be predetermined, varied according to present conditions (such as the signals received or calculations/determinations made according to the description herein) or otherwise within the scope of the present invention.

At operation 432, the controller 50 may determine whether the agricultural machine 10 has achieved a ground speed substantially equal to the increased speed commanded by the controller 50 at operation 422 above. For example, the controller 50 may receive the signal representative of the ground speed from the GPS sensor 44 and compare the signal speed to the increased commanded speed. If the ground speed, as indicated by the GPS signal, is substantially equal to the increased speed commanded by the controller 50, the method continues at operation 434. If the ground speed, as indicated by the GPS signal, is not substantially equal to the commanded increased speed, the method returns to operation 426. In an embodiment, operations 426 to 432 may be iterative and performed until the ground speed, as indicated by the GPS signal, is substantially equal to the increased speed commanded by the controller 50. Alternatively, the operations 426 to 432 may be performed a maximum number of times before the method proceeds to operation 434. In an embodiment, the maximum number of times may be five (5), although any number of iterations may be selected or determined.

At operation 434, the controller 50 may simultaneously transmit a second speed signal to the propel motor 32, decreasing the speed of the motor to the original operator-commanded speed, and a stop signal to the steering motor 38, returning it to its unactuated state.

### Crawl Condition/Mode B

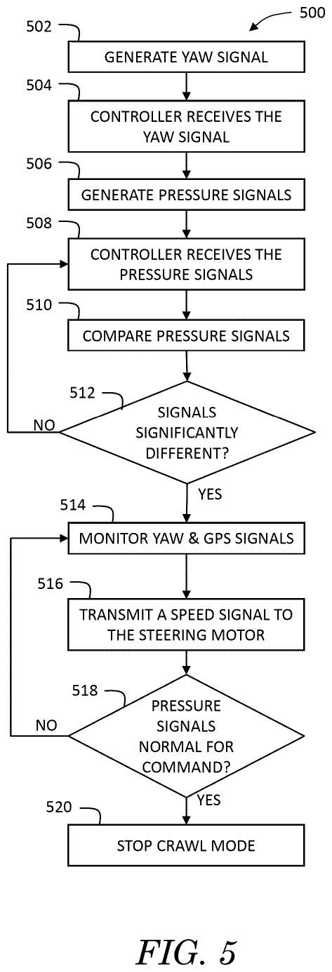

FIG. 5 is a flowchart illustrating an exemplary computer-implemented method 500 for determining whether the agricultural machine 10 is in a second crawl condition (referred to herein as “crawl condition B”) for activating a second selective crawl mode. As discussed above, at operation 314 of method 300, the controller 50 may monitor the input signals from the input sensors 40, 42, 44, 46, 48, 52, 54, and 56.

In the example embodiment, the controller 50 may determine whether the yaw sensor 42 is indicating that the agricultural machine 10 is starting to turn or rotate when such turning or rotating is not intended. For example, the yaw sensor 44 may receive data representative of an angular velocity of the agricultural machine 10 about its vertical axis and, at operation 502, may generate a signal representative of the angular velocity and transmit the signal to the controller 50. At operation 504, the controller 50 may receive the signal representative of the angular velocity from the yaw sensor 42. Based on the signal indicating an angular velocity of greater than or less than zero or a pre-determined threshold amount, the controller may determine that the agricultural machine 10 is turning or rotating about its vertical axis in an unintended manner.

In addition, the controller 50 may determine that one of the drive wheels 14 and 16 is slipping or spinning in the soil, causing the unintended rotation of the agricultural machine 10. For example, the pressure sensors A and B (reference characters 54 and 56) may sense respective pressures (for example, a hydraulic or pneumatic pressure) in respective lines coupled to the steering motor 38. At operation 506, the pressure sensors A and B may generate respective signals representative of the pressures and transmit the signals to the controller 50. At operation 508, the controller 50 may receive the signals from the pressure sensors A and B. At operation 510, the controller 50 may compare the signals from the pressure sensors A and B and, at operation 512, determine that the two signals do not match and are significantly different. For example, in an embodiment, the controller 50 may determine, based on the comparison, that the two signals indicate a pressure differential across the steering motor 38 greater than two hundred pounds per square inch (200 psi). It is noted that the pressure differential can be determined or pre-determined and can be any value that enables the agricultural machine 10 to function as described herein.

Based on the above condition determinations (i.e., that the agricultural machine 10 is in “crawl condition B”), the controller 50 may implement an associated selective crawl mode (referred to herein as “crawl mode B”). Crawl mode B includes actuating the steering motor 38 to apply additional torque to the drive wheel 14 or 16 that is slipping or spinning in the soil until the yaw sensor 42 indicates that the agricultural machine 10 is traveling in its intended direction, i.e., ceased its unintended rotation. After the yaw sensor 42 indicates that the agricultural machine 10 is performing as intended or after a predetermined period, the controller 50 may stop actuating the steering motor 38 to apply the additional torque to one of the drive wheels 14 and 16. These operations are described in more detail below.

At operation 514, the controller 50 may monitor the yaw sensor 42 and the GPS sensor 44. At operation 516, the controller 50 may transmit a speed signal to the steering motor 38, actuating the steering motor 38 in a first direction configured to steer the agricultural machine 10 in a direction opposite the angular velocity indicated by the yaw sensor 42. By actuating the steering motor 38 as such, the differential bevel gear arrangement 90 (shown in FIG. 2) applies additional torque to the slipping drive wheel 14 or 16. The controller 50 may actuate the steering motor 38 for a predetermined period. In an example embodiment, the first speed signal may actuate the steering motor 38 for a period of five seconds (5 s). It is noted, however, that the period may be any period that enables the agricultural machine 10 to function as described herein. The period(s) may be predetermined, varied according to present conditions (such as the signals received or calculations/determinations made according to the description herein) or otherwise within the scope of the present invention. For example, the controller 50 may actuate the steering motor 38 until the signal from the yaw sensor 42 indicates that the agricultural machine 10 is performing as intended.

At operation 518, the controller 50 may determine whether the signals from the pressure sensors A and B are normal for the commanded turn rate such that the agricultural machine 10 has stopped turning or rotating in an unintended manner, e.g., that the angular velocity is about zero or below a pre-determined threshold value. In an example, the controller 50 may receive the signals from the pressure sensors A and B and the signal representative of the angular velocity from the yaw sensor 42. If the pressures are normal for the commanded steering input and the angular velocity, as indicated by the yaw signal, does not indicate that the unintended rotation, reduced speed, or turning has ceased, the method may return to and continue at operation 514. Subsequent iterations of operation 516 may include continuation of the original speed signal or generation and transmission of another speed signal, according to various embodiments. If the angular velocity, as indicated by the yaw signal, has changed and indicates that the unintended rotation, reduced speed, or turning has ceased, at operation 520, the controller 50 may transmit a stop signal to the steering motor 38, returning it to its unactuated state.

### Crawl Condition/Mode C

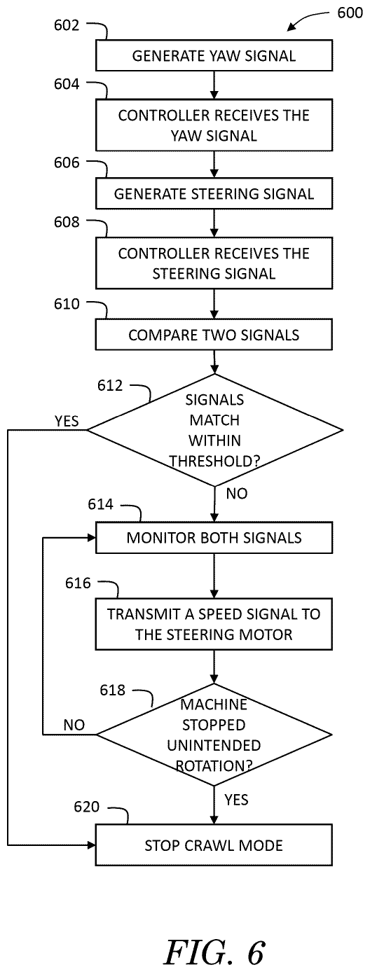

FIG. 6 is a flowchart illustrating an exemplary computer-implemented method 600 for determining whether the agricultural machine 10 is in a third crawl condition (referred to herein as “crawl condition C”) for activating a third selective crawl mode. As discussed above, at operation 314 of method 300, the controller 50 may monitor the input signals from the input sensors 40, 42, 44, 46, 48, 52, 54, and 56.

In the example embodiment, the controller 50 may determine whether the yaw sensor 42 is indicating that the agricultural machine 10 is turning or rotating at a rate commanded by the operator. For example, the operator may command a turn via the steering mechanism 28 (shown in FIG. 2) and the steering angle sensor 40 may transmit a signal indicative of the steering mechanism position. As discussed above, the yaw sensor 44 may receive data representative of an angular velocity of the agricultural machine 10 about its vertical axis and, at operation 602, may generate a signal representative of the angular velocity and transmit the signal to the controller 50. At operation 604, the controller 50 may receive the signal representative of the angular velocity from the yaw sensor 42.

Similarly, the steering angle sensor 40 may sense an angle or orientation of the steering mechanism 28 and, at operation 606, may generate a signal representative of the angle and transmit the signal to the controller 50. At operation 608, the controller 50 may receive the signal representative of the steering mechanism angle or orientation from the steering angle sensor 40.

The controller 50 may determine that the velocity or angular velocity does not match the steering mechanism angle or orientation. This mismatch may cause the agricultural machine 10 to move slower or turn at a rate different than that commanded by the operator. This may be indicative of one of the drive wheels 14 and 16 slipping and/or spinning on the ground surface. At operation 610, the controller 50 may compare the signals received from the yaw sensor 42 and the steering angle sensor 40. At operation 612, based on the comparison, the controller 50 may determine that the two (2) signals do not match, for example, within a predetermined threshold amount. For example, the yaw sensor 42 may indicate that the angular velocity of the agricultural machine 10 is greater than the commanded angular velocity indicated by the steering angle sensor 40. In such a scenario, a radially inner one of the drive wheels 14 and 16, relative to a direction of turning of the agricultural machine 10, may be slipping or spinning in the soil, resulting in the drive wheel moving across the ground at a speed less than the commanded speed. Alternatively, the yaw sensor 42 may indicate that the angular velocity of the agricultural machine 10 is less than the commanded angular velocity indicated by the steering angle sensor 40. In such a scenario, a radially outer one of the drive wheels 14 and 16, relative to a direction of turning of the agricultural machine 10, may be slipping or spinning in the soil, resulting in the drive wheel moving across the ground at a speed less than the commanded speed.

Based on the above condition determinations (i.e., that the agricultural machine 10 is in “crawl condition C”), the controller 50 may implement an associated selective crawl mode (referred to herein as “crawl mode C”). Crawl mode C includes actuating the steering motor 38 to apply additional torque to the drive wheel 14 or 16 that is slipping, causing the incorrect rotation of the agricultural machine 10 relative to the rotation amount commanded by the steering mechanism 28, as indicated by the steering angle sensor 40. After the yaw sensor 42 indicates that the agricultural machine 10 is performing as intended, the controller 50 stops actuating the steering motor 38 to apply the additional torque. These operations are described in more detail below.

At operation 614, the controller 50 may monitor the yaw sensor 42 and the steering angle sensor 40. At operation 616, the controller 50 may transmit a speed signal to the steering motor 38, actuating the steering motor 38 in a first direction configured to correct the mismatch between the signals received from the yaw sensor 42 and the steering angle sensor 40. By actuating the steering motor 38 as such, the differential bevel gear arrangement 90 (shown in FIG. 2) applies additional torque to the slipping drive wheel 14 or 16 to adjust the angular velocity of the agricultural machine 10, as indicated by the yaw sensor 42, to match the angular velocity command by the operator via the steering mechanism 28. The controller 50 may actuate the steering motor 38 until the signal from the yaw sensor 42 indicates that the agricultural machine 10 is performing as intended.

At operation 618, the controller 50 may determine whether the agricultural machine 10 is moving as intended and/or has stopped turning or rotating in an unintended manner. For example, the controller 50 may receive the signals representative of the angular velocity from the yaw sensor 42 and the steering angle sensor 40. The controller 50 may compare the two signals to one another. If the angular velocity, as indicated by the yaw signal, does not indicate that the unintended rotation or turning has ceased, i.e., the angular velocity is different than the steering mechanism angle or orientation, the method may return to and continue at operation 614. Subsequent iterations of operation 616 may comprise continuation of the original speed signal or generation and transmission of another speed signal, according to various embodiments. If the angular velocity, as indicated by the yaw signal, has changed and indicates that the unintended rotation or turning has ceased, i.e., the angular velocity matches the steering mechanism angle or orientation, at operation 620, the controller 50 may transmit a stop signal to the steering motor 38, returning it to its unactuated state. If no unintended rotation or turning was initially detected and/or crawl mode was not initiated (see “yes” output of operation 612) operation 620 may simply comprise continued normal operation of the machine 10.

### Manual Mode

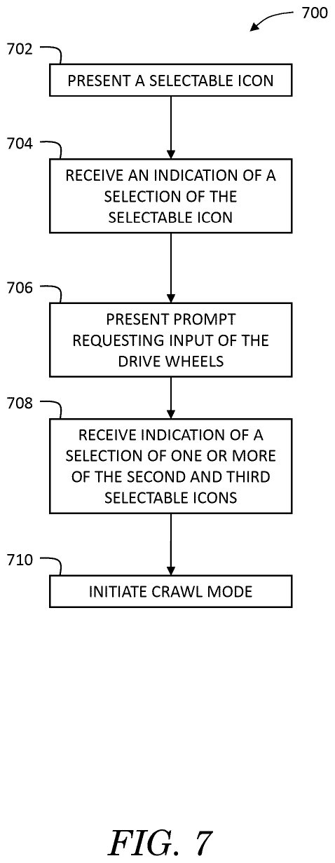

FIG. 7 is a flowchart illustrating an exemplary computer-implemented method 700 for implementation of a selective crawl mode of the agricultural machine 10 based on manual initiation by the operator of the agricultural machine 10, in accordance with embodiments of the present disclosure. When the operator of the agricultural machine 10 is stuck in the soil, the operator may manually initiate the method 300, which advantageously performs a crawl mode by actuating the steering motor 38 to apply torque from the steering motor 38 to one or more of the drive wheels 14 and 16. The operations described herein may be performed in the order shown in FIG. 7 or may be performed in a different order. Furthermore, some operations may be performed concurrently as opposed to sequentially. In addition, some operations may be optional.

The computer-implemented method 700 is described below, for ease of reference, as being executed by exemplary devices and components introduced with the embodiments illustrated in FIGS. 1A, 1B, and 2. In one embodiment, the method 700 may be implemented by the agricultural machine 10, via the controller 50 (shown in FIG. 2). The method 700 may be implemented on other computing devices and/or systems through the utilization of processors, transceivers, hardware, software, firmware, or combinations thereof. A person having ordinary skill will further appreciate that responsibility for all or some of the actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the operations outlined herein. The program(s) stored on the computer-readable medium(s) may instruct the processor or processing units to perform additional, fewer, or alternative actions, including those discussed elsewhere herein.

In the example, at operation 702, the controller 50 may present a selectable icon or button, for example, on a display of the controller 50. If operator has the agricultural machine 10 stuck, such that the drives wheels 14 and 16 are slipping or spinning in the soil, the operator may press the icon presented on the display to initiate the crawl mode. Upon selection of the icon or button, at operation 704, the controller may receive an indication of a selection of the selectable icon. In response, at operation 706, the controller 50 may present, on the display, a prompt requesting input of the drive wheels 14 and 16 that are stuck. The prompt may include a second selectable icon associated with the first drive wheel 14 and a third selectable icon associated with the second drive wheel 16. The operator may press one or more of the second and third selectable icons to indicate the stuck drive wheel(s). At operation 708, the controller may receive an indication of a selection of one or more of the second and third selectable icons. In response, at operation 710, the controller 50 may initiate one of the crawl modes discussed above by performing one of the methods 400, 500, and 600.

### Additional Considerations

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

The detailed description is to be construed as exemplary only and does not describe every possible embodiment because describing every possible embodiment would be impractical. Numerous alternative embodiments may be implemented, using either current technology or technology developed after the filing date of this patent, which would still fall within the scope of the invention.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

Having thus described various embodiments of the disclosure, what is claimed as new and desired to be protected by Letters Patent includes the following:

1. A control system for an agricultural machine, the agricultural machine having a harvesting component, a differential axle assembly, a steering mechanism, first and second drive wheels, and a steering motor coupled to the differential axle assembly and configured to increase torque applied to one of the first and second drive wheels while simultaneously decreasing torque applied to the other of the first and second drive wheels, the control system comprising:
a status sensor configured to interface with the harvesting component and generate a status signal representative of an operational status of the harvesting component;
a GPS sensor coupled to the agricultural machine and configured to generate a GPS signal representative of a ground speed of the agricultural machine;
one or more input sensors, each input sensor configured to generate an input signal; and
a controller communicatively coupled to the status sensor, the GPS sensor, and the one or more input sensors, the controller configured to:
receive the GPS signal from the GPS sensor;
based on the GPS signal, determine that the ground speed of the agricultural machine is below a threshold ground speed value;
receive the status signal from the status sensor;
based on the status signal, determine that the harvesting component is operating in an operating mode;
receive the one or more input signals from the one or more input sensors;
based on the one or more input signals, determine that the agricultural machine is in a crawl condition; and
based on the crawl condition determination, initiate a crawl mode corresponding to the crawl condition, wherein initiating the crawl mode comprises actuating the steering motor to increase the torque applied to one of the first and second drive wheels.

2. The control system in accordance with claim 1,
the one or more input sensors comprising a steering angle sensor, wherein the input signal of the steering angle sensor is representative of an angle of the steering mechanism of the agricultural machine,
the controller configured to:
detect a change of the angle of the steering mechanism based on the input signal of the steering angle sensor; and
based on the detected change, stop the crawl mode.

3. The control system in accordance with claim 1,
wherein the agricultural machine further includes a propel motor configured to drive the first and second drive wheels,
the one or more input sensors comprising a propel motor speed sensor, wherein the input signal of the propel motor speed sensor is representative of a speed of the propel motor,
wherein the operation to determine that the agricultural machine is in the crawl condition includes:
receiving the input signal of the propel motor speed sensor; and
determining that the input signal of the propel motor speed sensor and the GPS signal both indicate that the ground speed of the agricultural machine is below a commanded ground speed input to the controller by an operator of the agricultural machine.

4. The control system in accordance with claim 3,
the one or more input sensors including a first pressure sensor and a second pressure sensor,
the input signal of the first pressure sensor being representative of a first fluid pressure at a first side of the steering motor,
the input signal of the second pressure sensor being representative of a second fluid pressure at a second side of the steering motor,
the controller configured to:
receive the input signals of the first and second pressure sensors;
compare the input signals of the first and second pressure sensors; and
based on the comparison, determine that the input signals of the first and second pressure sensors match one another within a threshold amount.

5. The control system in accordance with claim 4, wherein the threshold amount is equal to or less than two hundred pounds per square inch (200 psi).

6. The control system in accordance with claim 4,
wherein actuating the steering motor to increase the torque applied to one of the first and second drive wheels includes:
actuating the steering motor in an alternating manner in a first direction and a second direction while commanding an increased ground speed relative to the commanded ground speed.

7. The control system in accordance with claim 6,
wherein actuating the steering motor in an alternating manner in a first direction and a second direction includes:
transmitting a first speed signal to the steering motor, the first speed signal actuating the steering motor in the first direction; and
transmitting a second speed signal to the steering motor, the second speed signal actuating the steering motor in the second direction opposite the first direction.

8. The control system in accordance with claim 7,
the controller configured to determine, before transmitting the second speed signal to the steering motor and based on the GPS signal, that the ground speed of the agricultural machine has not reached the increased ground speed commanded by the controller.

9. The control system in accordance with claim 7,
the controller configured to:
determine, after transmitting the second speed signal to the steering motor and based on the GPS signal, that the agricultural machine is moving at the increased ground speed; and
based on the determination, return the agricultural machine to the commanded ground speed.

10. The control system in accordance with claim 9, wherein returning the agricultural machine to the commanded ground speed comprises the controller transmitting a third speed signal to the propel motor commanding a propel motor speed decrease.

11. The control system in accordance with claim 1,
wherein the agricultural machine further includes a propel motor configured to drive the first and second drive wheels,
the one or more input sensors comprising:
a propel motor speed sensor,
a first pressure sensor, and
a second pressure sensor,
the input signal of the propel motor speed sensor being representative of a speed of the propel motor,
the input signal of the first pressure sensor being representative of a first fluid pressure at a first side of the steering motor, and
the input signal of the second pressure sensor being representative of a second fluid pressure at a second side of the steering motor,
wherein the operation to determine that the agricultural machine is in a crawl condition includes:
receiving the input signals of the propel motor speed sensor and the first and second pressure sensors;
determining that a predicted ground speed of the agricultural machine based on the input signal of the propel motor speed sensor does not match the ground speed of the agricultural machine indicated by the GPS signal;
compare the input signals of the first and second pressure sensors; and
based on the comparison, determine that the input signals of the first and second pressure sensors match one another within a threshold amount.

12. The control system in accordance with claim 11, wherein the threshold amount is equal to or less than two hundred pounds per square inch (200 psi).

13. The control system in accordance with claim 11,
wherein actuating the steering motor to increase the torque applied to one of the first and second drive wheels includes:
actuating the steering motor in an alternating manner in a first direction and a second direction, comprising:
transmitting a first speed signal to the steering motor, the first speed signal actuating the steering motor in the first direction; and
transmitting a second speed signal to the steering motor, the second speed signal actuating the steering motor in the second direction opposite the first direction; and
commanding an increased ground speed relative to a commanded ground speed input to the controller by an operator of the agricultural machine.

14. The control system in accordance with claim 1,
wherein the agricultural machine further includes a propel motor configured to drive the first and second drive wheels,
the one or more input sensors comprising a yaw sensor, wherein the input signal of the yaw sensor is representative of an angular velocity of the agricultural machine,
wherein the operation to determine that the agricultural machine is in a crawl condition includes:
receiving the input signal of the yaw sensor;
determining that the input signal of the yaw sensor indicates an angular velocity of greater than or less than zero.

15. The control system in accordance with claim 14,
the one or more input sensors further comprising a first pressure sensor and a second pressure sensor,
the input signal of the first pressure sensor being representative of a first fluid pressure at a first side of the steering motor,
the input signal of the second pressure sensor being representative of a second fluid pressure at a second side of the steering motor,
the controller being configured to:
receive the input signals of the first and second pressure sensors;
compare the input signals of the first and second pressure sensors; and
based on the comparison, determine that the input signals of the first and second pressure sensors do not match one another within a threshold amount.

16. The control system in accordance with claim 15, wherein the threshold amount is equal to or less than two hundred pounds per square inch (200 psi).

17. The control system in accordance with claim 15,
wherein actuating the steering motor to increase the torque applied to one of the first and second drive wheels includes:
transmitting a first speed signal to the steering motor, the first speed signal actuating the steering motor in a first direction configured to steer the agricultural machine in a direction opposite the angular velocity indicated by the input signal of the yaw sensor; and
determining, based on the input signal of the yaw sensor, that the angular velocity of agricultural machine has changed and is about zero; and
based on the determination of about zero angular velocity, transmitting a stop signal to the steering motor, returning the steering motor to an unactuated state.

18. The control system in accordance with claim 1,
wherein the agricultural machine further includes a propel motor configured to drive the first and second drive wheels,
the one or more input sensors comprising:
a yaw sensor, and
a steering angle sensor,
the input signal of the yaw sensor being representative of an angular velocity of the agricultural machine, and
the input signal of the steering angle sensor being representative of an angle of the steering mechanism of the agricultural machine;
wherein the operation to determine that the agricultural machine is in a crawl condition includes:
receiving the input signal of the yaw sensor;
receiving the input signal of the steering angle sensor;
determining that the input signal of the yaw sensor indicates an angular velocity that does not match an angle of the steering mechanism of the agricultural machine indicated by the input signal of the steering angle sensor.

19. The control system in accordance with claim 18,
wherein actuating the steering motor to increase the torque applied to one of the first and second drive wheels includes transmitting a speed signal to the steering motor, the speed signal actuating the steering motor in a first direction configured to correct the mismatch between the angular velocity indicated by the input signal of the yaw sensor and the angle of the steering mechanism of the agricultural machine indicated by the input signal of the steering angle sensor.

20. The control system in accordance with claim 19,
the controller configured to:
monitor the input signal of the yaw sensor and the input signal of the steering angle sensor;
determine that the angular velocity indicated by the input signal of the yaw sensor and the angle of the steering mechanism of the agricultural machine indicated by the input signal of the steering angle sensor match; and
based on the determination, transmit a stop signal to the steering motor, returning the steering motor to an unactuated state.
